(19) United States
(12) Patent Application Publication
(10) Pub. No.: US 2007/0002359 A1
(43) Pub. Date: Jan. 4, 2007

(54) Image forming system, image forming apparatus and data management method thereof

(75) Inventor: Sobko Sergey, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/476,852

(22) Filed: Jun. 29, 2006

(30) Foreign Application Priority Data
Jun. 29, 2005 (KR) 2005-56810

(51) Int. Cl. G06F 3/12; G06K 15/00

(52) U.S. Cl. 358/1.13; 358/1.16; 358/471

(57) ABSTRACT

An image forming system, an image forming apparatus, and a method of managing data of the image forming system, and the image forming apparatus. The image forming apparatus is in communication with a data storage server via a network, and includes a storage unit to store first data, and a data management unit to convert a format of the first data stored in the storage unit into a predetermined standard format and to upload the converted first data to the data storage server to be stored, and to reconvert the standard format of second data downloaded from the data storage server into a format capable of being used in the image forming apparatus and to store the second data. Accordingly, stored first data are converted to the standard format, is then uploaded to the data storage server such that a backup operation is performed, and the second data backed up in the data storage server can be downloaded to be reconverted to the format capable of being used in the image forming apparatus and stored such that the first data can be continuously used even when the system of the image forming apparatus is changed.

### CROSS-REFERENCE TO RELATED APPLICATIONS

This application claims the benefit under 35 U.S.C. § 119 of Korean Patent Application No. 2005-56810, filed on Jun. 29, 2005, the entire content of which is incorporated herein by reference.

### BACKGROUND OF THE INVENTION

1. Field of the Invention

The present general inventive concept relates to an image forming system, an image forming apparatus, and a method of managing data of the image forming system and the image forming apparatus, and in particular, to an image forming system which converts a format of data stored in a storage unit into a standard format to upload the data to a data storage server, downloads the data of the standard format stored in the data storage server to convert a format of the data into formats capable of being used in the image forming apparatus and stores the data in the storage unit, the image forming apparatus, and the method of managing data of the image forming system and the image forming apparatus.

2. Description of the Related Art

In general, a network image forming system is a system where at least one image forming apparatus and at least one host computer are connected to each other via a network such as a Local Area Network (LAN). This network image forming system can allow a plurality of host computers to share one image forming apparatus to thereby increase a usage efficiency of the image forming apparatus. In this case, examples of the image forming apparatus may include a printer, a facsimile, a copy machine, and so forth.

The image forming apparatus can have a mass storage unit such as a hard disk built in so as to store data associated with image formation. Data associated with printing (i.e., image forming), which is mainly stored in the mass storage unit built in the image forming apparatus, include print jobs, resource files, and accounting files. In this case, the print jobs are print data transmitted from one of the host computers and include digitized image data and attribute information of the print jobs. The resource files refer to data used in a firmware of the image forming apparatus such as resident font, e-forms, a macro(s), or the like. The accounting files refer to files in which specific information is accumulated which during operations of the image forming apparatus, and have state information of the image forming apparatus (e.g., amount of toner being supplied, amount of using print sheet, error history information), a number of print jobs transmitted per user, a list of the print jobs having the printing completed, and so forth.

In the conventional network image forming system, data associated with the printing as described above, cannot be used any more when errors occur in the mass storage unit built in the image forming apparatus.

In addition, when the image forming apparatus, which has been used, is replaced by a new image forming apparatus, the following problem may occur. Even when the data stored in the previous mass storage unit of the image forming apparatus is backed up to a data storage server, the new image forming apparatus can not use the back up data downloaded from the data storage server when data formats processed by the image forming apparatus and the new image forming apparatuses are different from each other.

### SUMMARY OF THE INVENTION

The present general inventive concept provides an image forming system, which converts a format of data stored in a storage unit into a standard format to upload the data to a data storage server, downloads the data stored in the data storage server to convert the standard format of the data into formats capable of being used in another image forming apparatus and stores the data in the storage unit, an image forming apparatus, and a method of managing data of the image forming system and the image forming apparatus.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an image forming apparatus in communication with a data storage server via a network, which includes a storage unit to store first data, and a data management unit to convert the first data stored in the storage unit into a predetermined standard format and to upload the first data to the data storage server to be stored, and to download second data from the data storage server in the standard format and to convert the second data downloaded from the data storage server into a format capable of being used in the image forming apparatus and to store the second data.

In addition, the image forming apparatus may further include a display unit to display a user interface to receive user setting instructions including information about an uploading function to upload the first data stored in the storage unit to the data storage server and a downloading function to download the second data stored in the data storage server.

Further, the user interface may include an item to select the first data to be uploaded from among all data stored in the storage unit and an item to set a period of uploading the selected first data to be uploaded to the data storage server.

In addition, the image forming apparatus may further include a control unit to control the data management unit such that the first data is uploaded to the data storage server according to the uploading period set through the user interface.

In this case, the first data includes at least one of a print job having image data and job attribute information, a resource file used in a firmware of the image forming apparatus, and an accounting file generated during an operation of the image forming apparatus.

In addition, when the first data is the print job, the job attribute information may be converted to the standard format defined by UPnP PrintBasic, and the image data may be converted in a bitmap format.

The foregoing and/or other aspects of the present general inventive concept are also achieved by providing an image forming system, which includes a data storage server to receive and to store first data transmitted from an external device, and to transmit the stored first data in a standard format in response to an external request, and an image forming apparatus in communication with the data storage server and including a storage unit to store second data, to convert the second data stored in the storage unit into the standard format to upload the second data to the data storage server, to download the first data in the standard format and to convert the first data downloaded from the data storage server into a format capable of being used in the image forming apparatus, and to store the converted first data in the storage unit.

The foregoing and/or other aspects of the present general inventive concept are also achieved by providing a method of managing data of an image forming apparatus, the method including converting a format of first data stored in a storage unit of the image forming apparatus into a predetermined standard format, and uploading the first data converted to the standard format to the data storage server to store the first data in the data storage server.

In addition, the method may further include downloading second data stored in the data storage server, and reconverting the standard format of the downloaded second data into a format capable of being used in the image forming apparatus.

The method may further include displaying a user interface to receive user setting instructions including information about an uploading function to upload the first data stored in the storage unit to the data storage server and a downloading function to download the second data stored in the data storage server.

In addition, the uploading of the first data may include uploading the first data to the data storage server according to the uploading period set through the user interface.

The foregoing and/or other aspects of the present general inventive concept are also achieved by providing a method of managing data of an image forming system, the method including converting a format of first data stored in a storage unit of an image forming apparatus into a predetermined standard format, uploading the first data converted to the standard format to the data storage server, and storing the uploaded first data at the data storage server.

In addition, the method may further include downloading second data stored in the data storage server, converting the standard format of the downloaded second data into a format capable of being used in the image forming apparatus, and storing the converted second data in the storage unit.

The foregoing and/or other aspects of the present general inventive concept are also achieved by providing an image forming apparatus, including a storage unit to store operation data of the image forming apparatus in a first format, and a data management unit to perform a backup operation by storing the operation data in a different location in a second format.

The foregoing and/or other aspects of the present general inventive concept are also achieved by providing an image forming apparatus, including a data management unit to retrieve backup operation data from a backup location in a standard data format and to store the backup operation data as operation data in the storage unit in an apparatus specific data format usable therein.

The foregoing and/or other aspects of the present general inventive concept are also achieved by providing an image forming apparatus network, including at least one image forming apparatus, and one or more host devices to transmit one or more print jobs to the at least one image forming apparatus, wherein the at least one image forming apparatus stores operational information and information associated with the one or more print jobs locally, converts the operational information and the information associated with the one or more print jobs to a standard format readable by any type of image forming apparatus and transmits the standard format information to a backup location for storage in the standard format.

The foregoing and/or other aspects of the present general inventive concept are also achieved by providing a data storage server usable with an image forming apparatus network and including storage capacity to receive operational data associated with a first image forming apparatus in a standard data format, to store the received operational data in the standard data format, and to provide the stored operational data in the standard data format to a second image forming apparatus upon request.

The foregoing and/or other aspects of the present general inventive concept are also achieved by providing a computer readable medium containing executable code to control an image forming apparatus, the medium including executable code to store operation data of the image forming apparatus in a first format, and executable code to perform a backup operation by storing the operation data of the image forming apparatus in a different location in a second format.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating an image forming system in accordance with an embodiment of the present general inventive concept;

FIG. 2 is a block diagram illustrating an image forming apparatus of the image forming system of FIG. 1;

FIG. 3 is a flow chart illustrating a method of uploading data of an image forming system in accordance with an embodiment of the present general inventive concept; and

FIG. 4 is a flow chart illustrating a method of downloading data of an image forming system in accordance with an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

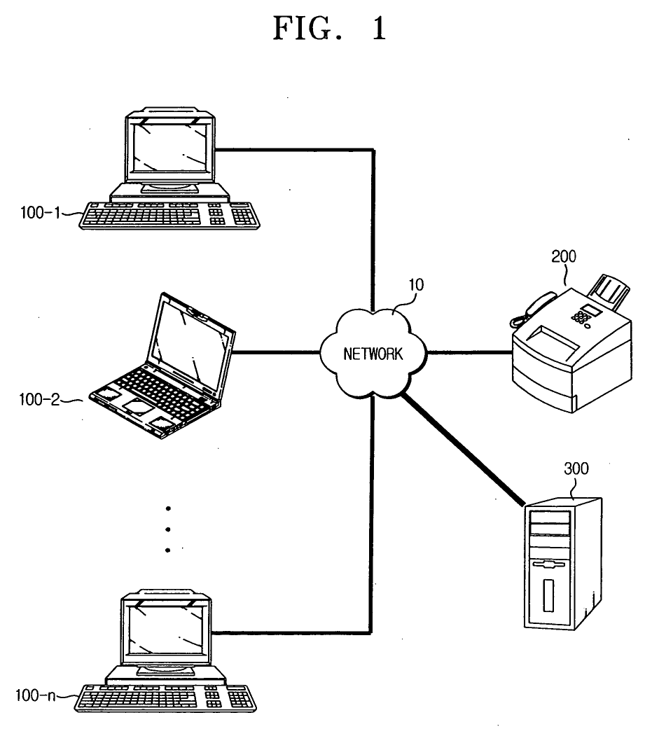

FIG. 1 is a block diagram illustrating an image forming system in accordance with an embodiment of the present general inventive concept.

Referring to FIG. 1, the image forming system according to the present general inventive concept includes first to nth host computers 100-1, 100-2, . . . , 100-n, an image forming apparatus 200, and a data storage server 300 which are connected to each other via a network 10. The network 10 can be formed by a Local Area Network (LAN), a sharer, such as a HUB, an Internet network, or an intranet network.

The first to nth host computers 100-1, 100-2, . . . , 100-n are apparatuses which generate print jobs and transmit data to a printing apparatus such as the image forming apparatus 200. The print jobs are generated with a format capable of being used (i.e., read) in the image forming apparatus 200. For example, each of the first to nth host computers 100-1, 100-2, . . . , 100-n has a built-in printer driver (not shown) capable of converting a format of a document to print into a printing data format capable of being interpreted in the image forming apparatus 200.

The image forming apparatus 200 executes the print jobs transmitted from the first to nth host computers 100-1, 100-2, . . . , 100-n. In particular, the image forming apparatus 200 can convert a format of data such as the print jobs, resource files and accounting files stored in a storage unit (not shown) into a predetermined standard format, and upload the converted data to the data storage server 300. The image forming apparatus 200 can download the print jobs, the resource files and the accounting files stored in the data storage server 300 all of which have the standard format, reconvert the standard format of the data into a format capable of being used in the image forming apparatus 200, and store the converted data in the storage unit.

The data storage server 300 stores the print jobs, the resource files, the accounting files, and so forth which have been converted in the standard format and transmitted from the image forming apparatus 200. The data storage server 300 also transmits the corresponding print job, the resource file, and the accounting file, which have been requested to be downloaded upon receipt of a download request for the stored data received from the image forming apparatus 200.

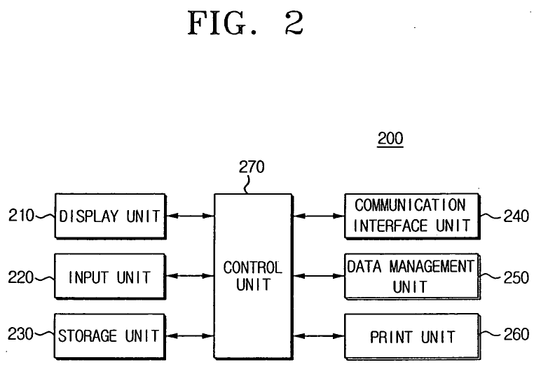

Hereinafter, the image forming apparatus 200 according to an embodiment of the present general inventive concept will be described in detail with reference to FIG. 2.

FIG. 2 is a block diagram illustrating the image forming apparatus 200 of FIG. 1.

Referring to FIGS. 1 and 2, the image forming apparatus according to the present embodiment includes a display unit 210, an input unit 220, a storage unit 230, a communication interface unit 240, a data management unit 250, a print unit 260, and a control unit 270.

The display unit 210 may employ an LCD panel or the like, and displays menus to enable selection of operation state information of the image forming apparatus 200 and various functions supported by the image forming apparatus 200 under the control of the control unit 270. In particular, the display unit 210 of the present embodiment displays a user interface to receive a user setting instruction with respect to an uploading function to upload the data stored in the storage unit 230 to the data storage server 300 and a downloading function to download the data stored in the data storage server 300 under the control of the control unit 270.

In this case, the user interface may have an item to enable the user to select desired data to be uploaded to the data storage server 300 from among all the data stored in the storage unit 230 and an item to set a period of uploading the data to the data storage server 300. In addition, the user interface may have an item to select desired data to be downloaded from among the data stored in the data storage server 300.

The input unit 220 receives a user instruction to set or select various functions supported by the image forming apparatus 200, and to this end, can have a plurality of input buttons, input devices, and/or a touch screen. In particular, the input unit 220 of the present embodiment receives the user setting instruction such as an uploading instruction of the user to upload the data selected from among all the data stored in the storage unit 230, and a downloading instruction to download the data selected from among all the data stored in the data storage server 300, and transmits data associated with the user instruction to the control unit 270.

The storage unit 230 stores various control programs used to implement functions of the image forming apparatus 200 and print jobs set to be stored in the image forming apparatus 200 under the control of the control unit 270. In particular, the storage unit 230 of the present embodiment can be implemented by a mass storage unit (e.g., a hard disk) such that print jobs, resource files, accounting files, etc. can be stored.

The communication interface unit 240 forms an interface with the first to nth host computers 100-1, 100-2, . . . , 100-n such that data associated with printing tasks including the print jobs can be transmitted/received to/from the image forming apparatus 200 (i.e., transceived). In addition, the communication interface unit 240 transceives the print jobs, the resource files, and the accounting files, which are all converted in the standard format, between the image forming apparatus 200 and the data storage server 300.

The data management unit 250 reads out data associated with the print jobs, the resource files, and the accounting files stored in the storage unit 230, converts a format of the read data (i.e., the format capable of being used in the image forming apparatus 200) into the standard format, and transmits the converted data to the data storage server 300 under the control of the control unit 270. In addition, when the data associated with the print jobs, the resource files, and the accounting files, which have the standard format and are stored in the data storage server 300, are downloaded to the image forming apparatus 200, the data management unit 250 reconverts the standard format of the downloaded data associated with the print jobs, the resource files, and the accounting files into the format capable of being used in the image forming apparatus 200, and stores the reconverted data in the storage unit 230.

The data management unit 250 can apply different standard formats according to types of data so that the data can be converted in this manner. For example, when the data to be uploaded to the data storage server 300 are print jobs, the data management unit 250 converts job attribute information to standard data formats defined by UPnP PrintBasic, and converts image data to simple formats such as a bitmap such that the data of different standard formats can be uploaded to the data storage server 300.

Accordingly, another image forming apparatus (not shown) that has a different system from the image forming apparatus 200 can download the data that is converted into the standard format and backed up in the data storage server 300 by the image forming apparatus 200. In other words, the other image forming apparatus can download corresponding data from the data storage server 300 and reconvert the standard format of the data into formats capable of being used therein.

The print unit 260 executes printing tasks on the print jobs stored in the storage unit 230 under the control of the control unit 270.

The control unit 270 controls the overall operation of the image forming apparatus 200. In particular, the control unit 270 of the present embodiment controls the data management unit 250 such that the data management unit 250 converts the format (i.e., the format that is capable of being used in the image forming apparatus 200) of the data to be uploaded into the standard format according to the uploading period set through the user interface and uploads the data from the image forming apparatus 200 to the data storage server 300 via the communication interface unit 240. In addition, when the downloading instruction is received from the user via the input unit 220, the control unit 270 requests the corresponding data to be downloaded from the data storage server 300.

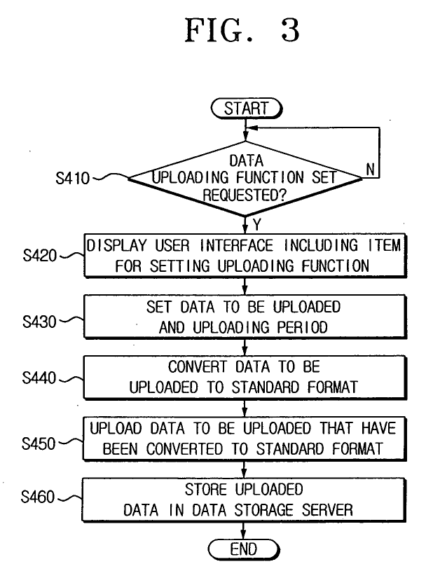

FIG. 3 is a flow chart illustrating a method of uploading data of an image forming system in accordance with an embodiment of the present general inventive concept. The method of FIG. 3 may be performed by the image forming system of FIG. 1 and/or the image forming apparatus 200 of FIG. 2. Accordingly, for illustration purposes, the method of FIG. 3 is described below with reference to FIGS. 1 and 2.

Referring to FIGS. 1 to 3, when an uploading function setting request for the data that is stored in the storage unit 230 occurs (operation S410), the display unit 210 displays the user interface to set the uploading functions including the item to select the data to be uploaded to the data storage server 300 from among all the data stored in the storage unit 230 and the item to set the period of uploading the data to the data storage server 300 under the control of the control unit 270 (operation S420). Accordingly, the data to be uploaded and the uploading period are set (operation S430). In this case, when the user requests the uploading function without setting the uploading period, the data to be uploaded may be immediately uploaded.

The data management unit 250 then reads out the data to be uploaded from the storage unit 230, and converts the upload data to the standard format (operation S440). The data management unit 250 then uploads the standard format data via the communication interface unit 240 according to the uploading period (operation S450), and stores the uploaded data in the data storage server 300 (operation S460).

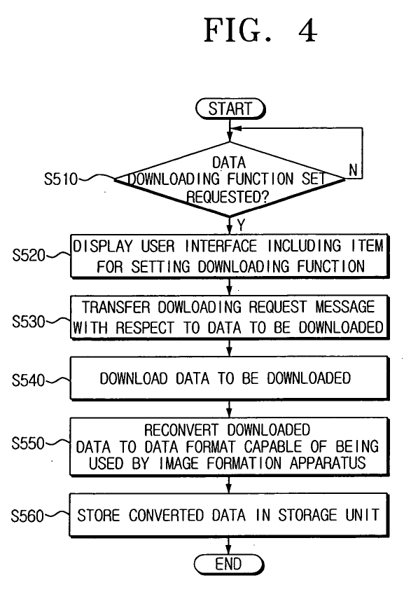

FIG. 4 is a flow chart illustrating a method of downloading data of an image forming system in accordance with an embodiment of the present general inventive concept. The method of FIG. 4 may be performed by the image forming system of FIG. 1 and/or the image forming apparatus 200 of FIG. 2. Accordingly, for illustration purposes, the method of FIG. 4 is described below with reference to FIGS. 1 and 2.

Referring to FIGS. 1, 2, and 4, when a downloading function setting request for the data that is stored in the data storage sever 300 occurs (operation S510), the display unit 210 displays the user interface to set the downloading functions including the item to select the data to be downloaded by the user from among the data stored in the data storage server 300 under the control of the control unit 270. Accordingly, the data to be downloaded is set (operation S520).

The control unit 270 then transmits a downloading request message about the data to be downloaded to the data storage server 300 (operation S530). Accordingly, the data is downloaded (operation S540).

The data management unit 250 then converts the standard format of the data downloaded from the data storage server 300 into the format capable of being used in the image forming apparatus 200 (operation S550), and stores the downloaded data in the storage unit 230 under the control of the control unit 270 (operation S560).

The present general inventive concept may be embodied as executable code in computer readable media including storage media such as magnetic storage media (ROMs, RAMs, floppy disks, magnetic tapes, etc.), optically readable media (CD-ROMs, DVDs, etc.), and carrier waves (transmission over the Internet). For example, the control unit 270 may be implemented in software.

According to the various embodiments of the present general inventive concept as described above, by uploading data stored in a storage unit to a data storage server so that a backup operation is performed, the backup data can be downloaded and used even when errors occur in the storage unit of an image forming apparatus. In addition, the upload data is converted to a standard format and stored in the data storage server at the time the backup operation is performed such that even when the image forming apparatus is replaced by a new image forming apparatus having a different system, the data that is converted to the standard format can be reconverted into formats capable of being used in the replacement (i.e., new) image forming apparatus and stored in the storage unit for continuous use.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a storage unit to store operation data of the image forming apparatus in a first format; and
a data management unit to perform a backup operation by storing the operation data in a different location in a second format.

2. The image forming apparatus according to claim 1, wherein the operation data of the image forming apparatus comprises at least one of:
print job information about one or more print jobs received from one or more host devices;
a resource file used in a firmware of the image forming apparatus; and
an accounting file that is created during an operation of the image forming apparatus.

3. The image forming apparatus according to claim 1, wherein the data management unit converts the operation data from the first format to the second format that is readable by any type of image forming apparatus before performing the backup operation.

4. The image forming apparatus according to claim 1, wherein the backup operation comprises transmitting the operation data to a data storage server.

5. The image forming apparatus according to claim 1, wherein the operation data comprises information about a configuration of a printer network including a plurality of host devices and the image forming apparatus and relationships between the image forming apparatus and the host devices.

6. The image forming apparatus according to claim 1, further comprising:
a user interface unit to enable a selected part of the operation data to be stored at the different location.

7. The image forming apparatus according to claim 1, wherein when an error occurs in the operation data stored in the storage unit, the data management unit retrieves the operation data stored at the different location.

8. An image forming apparatus, comprising:
a data management unit to retrieve backup operation data from a backup location in a standard data format and to store the backup operation data as operation data in the storage unit in an apparatus specific data format usable therein.

9. The image forming apparatus according to claim 8, wherein the backup operation data is stored at a different location and is originally stored by another image forming apparatus.

10. An image forming system, comprising:
a data storage server to receive and store first data transmitted from an external device, and to transmit the stored first data in a standard format in response to an external request; and
an image forming apparatus in communication with the data storage server and including a storage unit to store second data, to convert the second data stored in the storage unit into the standard format to upload the second data to the data storage server, to download the first data in the standard format and to convert the first data into a format capable of being used therein, and to store the converted first data in the storage unit.

11. The image forming system according to claim 10, wherein the first and second data comprise at least one of a print job having image data and job attribute information, a resource file used in a firmware of the image forming apparatus, and an accounting file generated during an operation of the image forming apparatus.

12. The image forming system according to claim 11, wherein when the first and second data comprise the print job, the job attribute information is converted into a data format defined by UpnP PrintBasic, and the image data is converted into a bitmap format.

13. The image forming system according to claim 10, further comprising:
at least one host device to transmit one or more print jobs to the image forming apparatus.

14. A method of managing data of an image forming apparatus in communication with a data storage server via a network, the method comprising:
converting a format of first data stored in a storage unit of the image forming apparatus into a standard format; and
uploading the first data converted into the standard format to the data storage server to store the uploaded first data in the data storage server.

15. The method according to claim 14, further comprising:
downloading second data stored in the data storage server; and
reconverting the standard format of the downloaded second data into a format capable of being used in the image forming apparatus.

16. The method according to claim 15, further comprising:
displaying a user interface to receive user setting instructions including information about an uploading function to upload the first data stored in the storage unit to the data storage server and a downloading function to download the second data stored in the data storage server.

17. The method according to claim 16, wherein the displaying of the user interface comprises:
displaying an item to enable a selection of the first data to be uploaded from among all data stored in the storage unit; and
displaying an item to enable setting a period of uploading the selected first data to be uploaded to the data storage server.

18. The method according to claim 17, wherein the uploading of the first data comprises:
uploading the first data to the data storage server according to the uploading period set through the user interface.

19. The method according to claim 14, wherein the first data comprise at least one of a print job having image data and job attribute information, a resource file used in a firmware of the image forming apparatus, and an accounting file generated during an operation of the image forming apparatus.

20. The method according to claim 19, wherein when the first data comprises the print job, the job attribute information is converted into the standard format defined by UpnP PrintBasic, and the image data is converted into a bitmap format.

21. A method of managing data of an image forming system including an image forming apparatus having a storage unit to store first data and a data storage server in communication with the image forming apparatus via a network, the method comprising:
converting a format of the first data stored in the storage unit into a predetermined standard format;
uploading the first data converted to the standard format to the data storage server; and
storing the uploaded first data at the data storage server.

22. The method according to claim 21, further comprising:
downloading second data stored in the data storage server;
converting the standard format of the downloaded second data into a format capable of being used in the image forming apparatus; and
storing the converted second data in the storage unit.

23. An image forming apparatus network, comprising:
at least one image forming apparatus; and
one or more host devices to transmit one or more print jobs to the at least one image forming apparatus,
wherein the at least one image forming apparatus stores operational information and information associated with the one or more print jobs locally, converts the operational information and the information associated with the one or more print jobs to a standard format readable by any type of image forming apparatus, and transmits the standard format information to a backup location for storage.
